(19) United States
(12) Patent Application Publication
(10) Pub. No.: US 2014/0001333 A1
(43) Pub. Date: Jan. 2, 2014

(54) Ladder safety device

(71) Applicant: John Daniel Stephen, Etobicoke (CA)

(72) Inventor: John Daniel Stephen, Etobicoke (CA)

(21) Appl. No.: 13/507,443

(22) Filed: Jun. 29, 2012

(51) Int. Cl. E06C 7/00

(52) U.S. Cl. 248/530

(57) ABSTRACT

A ladder safety device for stabilizing and anchoring the side rails of a ladder on a supporting surface when in an upright operative position. The safety device is attached to the lower end of at least one side rail and includes a spike axially slidable and lockable in a sleeve rotatably mounted on the rail for driving into the underlying ground perpendicular to the ground when in its extended operative position and retracted for self-storage during transport and non-use.

### BACKGROUND OF THE INVENTION

(i) Field of the Invention

This invention relates to a ladder safety device and, more particularly, relates to a ladder safety device for stabilizing and anchoring the side rails of a ladder to a supporting surface.

(ii) Description of the Related Art

Numerous devices have been developed for stabilizing and anchoring the legs of a ladder on a supporting surface when the ladder is in an upright operative position leaning against a wall or eaves of a roof. U.S. Pat. No. 5,669,642, for example, discloses a ladder stabilizer for use on uneven terrain whereby the stabilizer can be removably attached to the bottom end of a ladder rail at a desired height by bolts passing through the rail and through a pair of holes among a plurality of vertically-spaced staggered holes in a mounting slider plate. A self-leveling shoe pivotally attached to the bottom of the slider plate supports a pair of stakes spring loaded to a normally-retracted position and adapted to be driven into the terrain.

U.S. Pat. No. 4,007,807 discloses prongs hinged to the bottoms of ladder stiles to face downwardly for driving into the ground by standing on a ladder rung and pivoted upwardly for use on hard surface such as concrete. A supplementary anchor stake or a weight box may be used with a chain for connecting the stake or weight box to the ladder stiles to add stability to the ladder.

It is a principal object of the present invention to provide a simple, reliable and inexpensive stabilizer for anchoring a ladder in its upright position during use.

It is another object of the present invention to provide a ladder stabilizer readily attachable to ladder rails and which may be easily extended to its operative position for use and retracted for self-storage during transportation and non-use.

### SUMMARY OF THE INVENTION

In its broad aspect the ladder stabilizer of my invention for attachment to a lower end of at least one side rail of a ladder consisting of a pair of parallel, space-apart side rails joined by a plurality of equispaced rungs, comprises a mounting plate for attachment to the side rail, a sleeve, means for rotatably attaching and locking the sleeve to the mounting plate and a spike slidably mounted for axial travel in the sleeve from a retracted engaging position storage or transport position to an extended, ground engaging position. The means for rotatably attaching and locking the sleeve to the mounting plate comprises a pair of opposed plates having mutually engaging interior faces with equispaced radial teeth formed thereon and opposite exterior faces, means for mounting one exterior face on the mounting plate and means for connecting the other exterior face to the sleeve, and a threaded bolt anchored to one opposed plate and passing through the other opposed plate and through the side rail whereby tightening of the bolt draws the opposed plates together in angular locking engagement and releasing the bolt frees the opposed plates from each other for rotation of one of the plates and the sleeve connected thereto.

The ladder stabilizer additionally comprises an eye ring attached to the side rail, the spike having a distal end with a lateral extension formed thereon for engagement by the eye ring during storage and transport.

### BRIEF DESCRIPTION OF THE DRAWINGS

The process of the invention will now be described with reference to the accompanying drawings, in which:

FIG. 1 is a perspective view of a ladder in its operative position having the stabilizer of the invention shown attached to the lower ends of the ladder rails in a retracted position;

FIG. 2 is an enlarged perspective view of the lower end of the ladder shown in FIG. 1;

FIG. 3 is a side elevation of the ladder standing vertically upright showing the stabilizer in plan view;

FIG. 4 is a side elevation of the ladder in an inclined position on a hard surface showing the stabilizer released and pivoted clockwise from its inoperative position;

FIG. 5 is a side elevation showing the stabilizer pivoted counter-clockwise preparatory to engagement with the ground;

FIG. 6 is a side elevation showing the spike driven into the ground for anchoring the ladder rail;

FIG. 7 is a perspective view of a pair of the stabilizer spikes driven into the ground; and

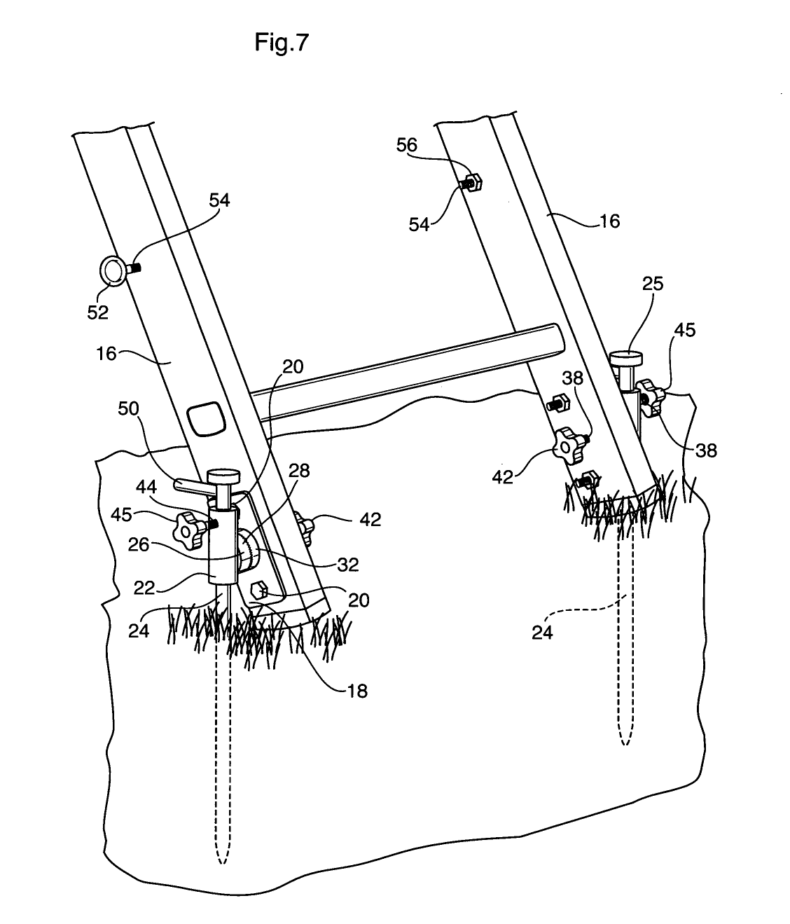

FIG. 8 is an exploded end elevation, partly in section, taken along line 7-7 illustrating the components of the stabilizer pivotal mechanism.

### DESCRIPTION OF THE PREFERRED EMBODIMENT

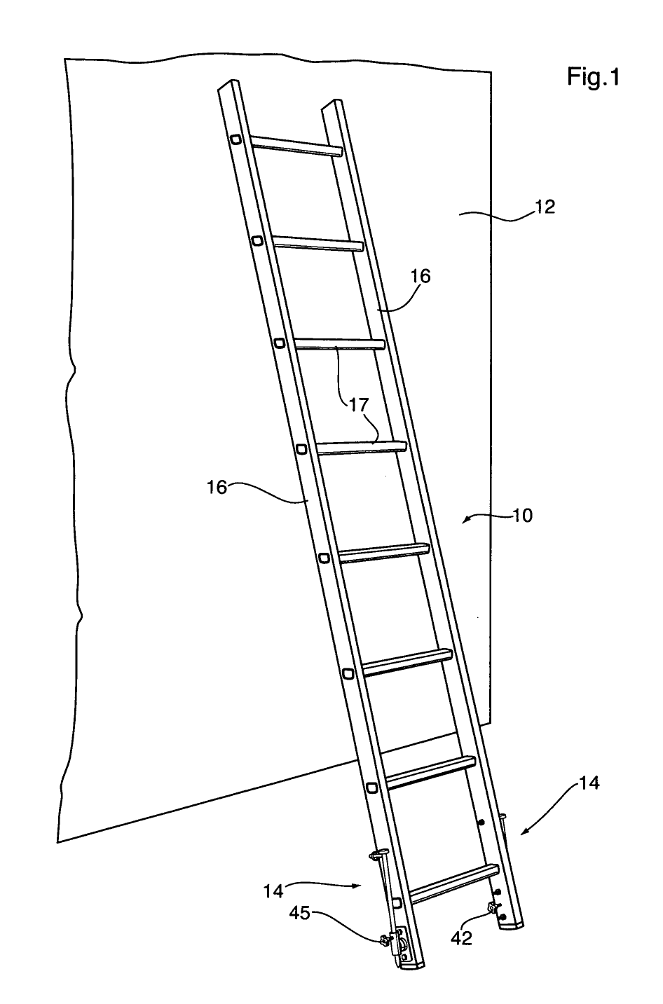

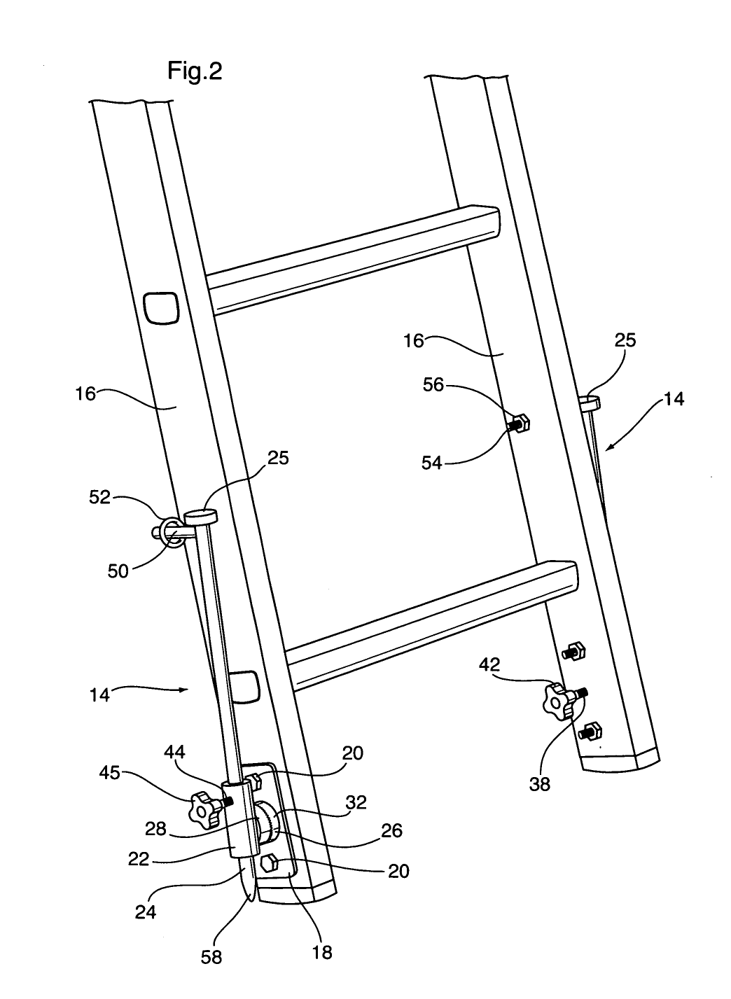

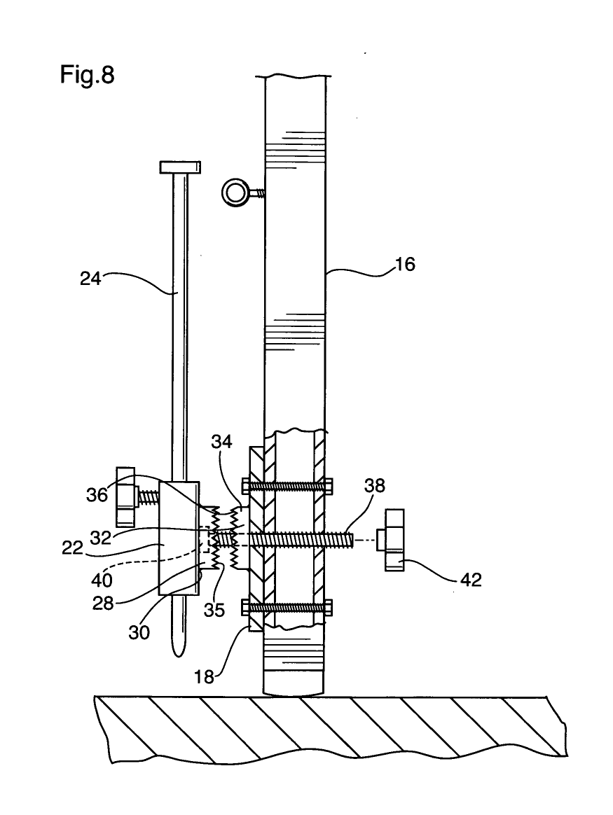

With reference to FIG. 1, ladder 10 consisting of a pair of parallel, spaced-apart side stiles or rails 16 joined by equispaced rungs 17 is shown in a operative upright position leaning against wall 12. A preferred embodiment of ladder stabilizer 14 of the invention is shown attached to the bottom end of each rail 16, as shown more clearly in FIG. 2. Each stabilizer 14 comprises a plate 18 adapted to be attached to the outer side of a rail 16 by a pair of spaced-apart self-tapping screws 20 or the like threaded fastener passing through holes formed in plate 18. A sleeve 22 adapted to slidably receive spike 24 is rotatably connected to plate 18 by a two-component pivotal locking mechanism 26 having one half 28 attached to sleeve 22 such as by a weld 30 and an opposite half 32 attached to plate 18 such as by a weld 34, shown most clearly in FIG. 8. The opposing faces of halves 28, 32 of mechanism 26 have equispaced radial teeth 35, 36 adapted to mate and engage each other when drawn together by threaded bolt 38. The head 40 of bolt 38 is centrally seated in half 26 and the bolt shank passes through the center of half 32 and through rail 16 to receive a nut such as a wing-nut or knurled knob 42 which is tightened to draw the opposed halves 28, 32 together in angular locking engagement.

Elongated spike 24 is slidably mounted in sleeve 22 and can be locked at a desired axial position in sleeve by set-screw 44 threaded into sleeve 22 and having an inner end, not shown, adapted to abut spike 24. Set-screw 44 preferably has a knurled knob 45 at its distal end to facilitate loosening and tightening, or a conventional set-screw requiring an allen wrench for loosening and tightening spike 24 within sleeve 22.

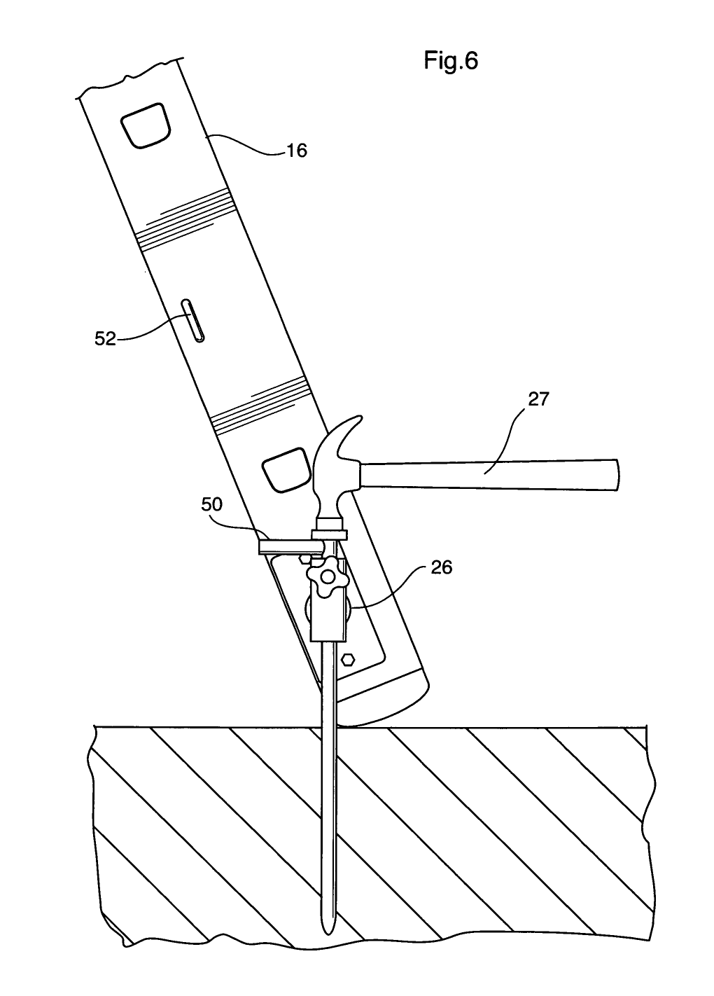

The upper distal end of spike 24 as viewed in the drawings preferably has a head 25 for driving with a hammer 27, as shown in FIG. 6, and has a lateral extension 50 adapted to fit into eye 52 of eye-bolt 54 attached to rail 16 by nut 56 to lock the spike on rail 16.

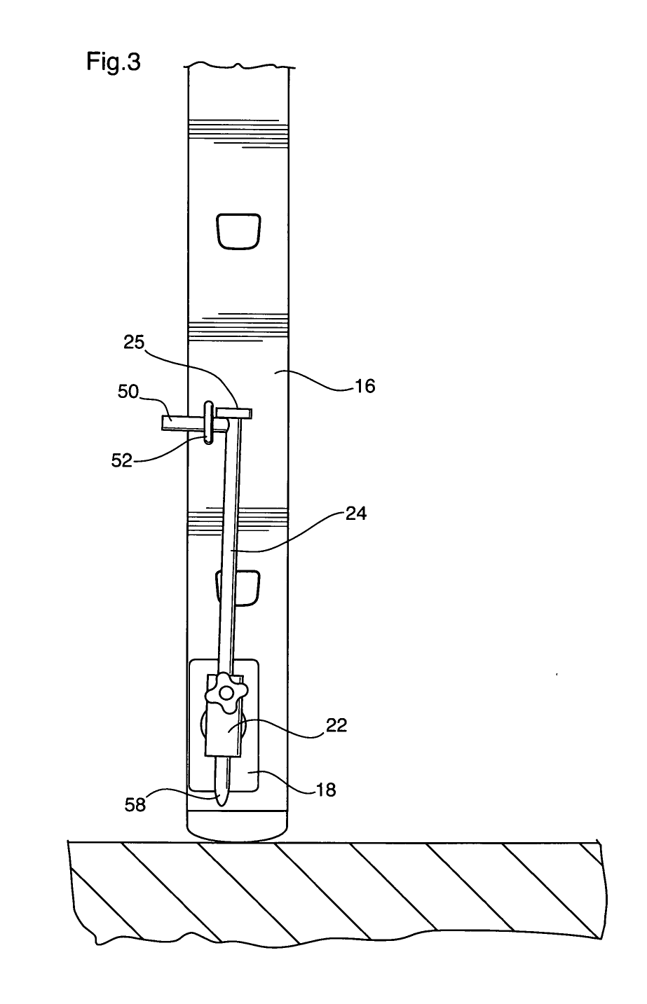

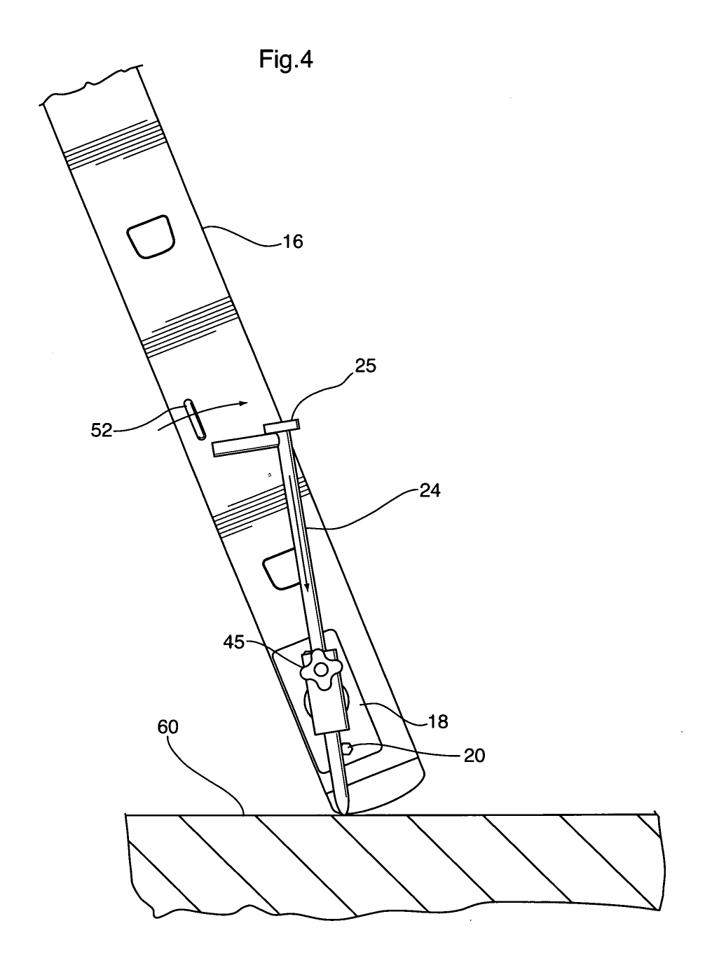

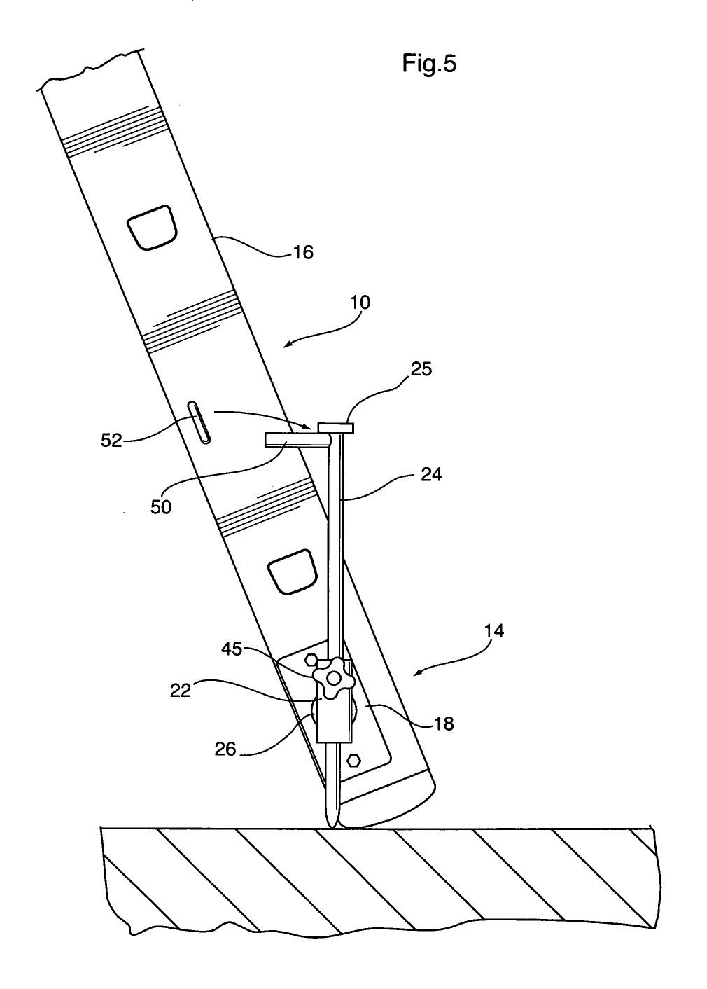

The stabilizer 14 is shown in its retracted inoperative position in FIGS. 1-3 for storage and transport. With reference to FIG. 4, knob 42 and set-screw 44 are loosened for use of the stabilizer, permitting spike 24 to be pivoted clockwise to the position shown in FIG. 4, and thus free of eye 52, and slid axially downwardly. The spike can then be pivoted clockwise to the position as shown in FIG. 5 substantially perpendicular to the ground, knob 42 tightened to lock the mechanism 26, and the spike driven into the ground such as by a hammer 27 as shown in FIG. 6. Knob 44 is then tightened to lock spike 24 in sleeve 22.

The angle of the spike relative to the longitudinal axis of the rail 16 and the ground 17 can be adjusted as desired prior to driving of the spike into the ground. Release of the spike by retraction from the ground is facilitated by gripping or striking lateral extension 50 upwardly. The device can then be stored by loosening knob 42 and set-screw 44, inserting extension 50 into eye 52 by pivoting spike counter-clockwise, and tightening wing-nut 42 and set-screw 44.

The ladder stabilizer of the invention provides a number of important advantages. The stabilizer can be readily attached to the rails of a ladder. The device can be easily actuated for use from its storage position and the spike adjusted to suit the angle defined by the ladder and the ground to enable the spike to be driven into the ground perpendicular thereto.

It will be understood that other embodiments and examples of the invention will be readily apparent to a person skilled in the art, the scope and purview of the invention being defined in the appended claims.

1. A ladder stabilizer for attachment to a lower end of at least one side rail of a ladder consisting of a pair of parallel, space-apart side rails joined by a plurality of equispaced rungs, comprising a mounting plate for attachment to the side rail, a sleeve, means for rotatably attaching and locking the sleeve to the mounting plate, a spike slidably mounted for axial travel in the sleeve from a retracted position to an extended ground engaging position, and means for locking the spike in the sleeve.

2. A ladder stabilizer as claimed in claim 1, in which the means for rotatably attaching and locking the sleeve to the mounting plate comprises a pair of opposed plates having mutually engaging interior faces and opposite exterior faces, means for connecting one exterior face to the mounting plate and means for connecting the other exterior face to the sleeve, and a threaded bolt anchored to one opposed plate and passing through the other opposed plate and through the side rail whereby tightening of the bolt draws the opposed plates together in angular locking engagement and loosening the bolt releases the opposed plates from each other for rotation of one of the plates and the sleeve thereon.

3. A ladder stabilizer as claimed in claim 2, in which the mutually engaging interior faces of the opposed plates have equispaced radial teeth formed thereon.

4. A ladder stabilizer as claimed in claim 2, additionally comprising an eye ring attached to the side rail, the spike having a distal end with a lateral extension formed thereon for engagement by the eye ring.
